(19) United States
(12) Patent Application Publication
(10) Pub. No.: US 2014/0356705 A1
(43) Pub. Date: Dec. 4, 2014

(54) ENCAPSULATED Li2S NANOPARTICLES FOR Li/S BATTERIES WITH ULTRAHIGH ENERGY DENSITIES AND LONG CYCLE LIFE

(71) Applicant: Leon L. Shaw, Chicago, IL (US)

(72) Inventor: Leon L. Shaw, Chicago, IL (US)

(21) Appl. No.: 14/291,141

(22) Filed: May 30, 2014

Related U.S. Application Data
(60) Provisional application No. 61/828,983, filed on May 30, 2013.

(51) Int. Cl. H01M 4/36; H01M 4/62; H01M 4/04; H01M 4/136; H01M 4/1393; H01M 4/1391; H01M 4/58; C01B 17/40

(52) U.S. Cl. CPC H01M 4/366; H01M 4/58; H01M 4/62; C01B 17/40; H01M 4/136; H01M 4/1393; H01M 4/1391; H01M 4/0428; H01M 4/0416; C01P 2004/03; C01P 2004/04; C01P 2004/64
USPC 429/212; 429/231.95; 427/122; 427/126.3

(57) ABSTRACT

Encapsulated lithium sulfide particles, e.g., Li₂S nanoparticles, as well as associated or corresponding novel cathodes of or for Li/S batteries and methods of fabrication such as to effectively minimize or desirably overcome or resolve one or more of the issues that commonly contribute to rapid capacity fading of conventional Li/S batteries during cycling.

### CROSS REFERENCE TO RELATED APPLICATION

This application claims the benefit of U.S. Provisional Application, Ser. No. 61/828,983, filed on 30 May 2013. The co-pending Provisional Patent Application is hereby incorporated by reference herein in its entirety and is made a part hereof, including but not limited to those portions which specifically appear hereinafter.

### BACKGROUND OF THE INVENTION

1. Field of the Invention

This invention relates generally to batteries and, more specifically, to Li/S batteries and the manufacture thereof.

2. Description of Related Art

Lithium-sulfur (Li/S) batteries have recently attracted significant attention because they exhibit very high theoretical specific energy (2500 Wh/kg), five times higher than that of the commercial LiCoO₂/graphite batteries. As a result, they are strong contenders for next-generation energy storage such as may find application in areas such as portable electronics, electric vehicles, and storage systems for renewable energy such as wind power and solar energy, for example. In addition, sulfur is low cost and exhibits nontoxicity. Unfortunately, the charge capacity of conventional Li/S batteries, however, typically fades quickly during cycling. The following three critical issues typically contribute to rapid capacity fading of Li/S batteries during cycling:
(i) dissolution of polysulfides into the electrolyte,
(ii) large volume expansion of sulfur during cycling, and
(iii) the insulating nature of Li₂S and S.

For example, dissolved polysulfides can result in diffusion of sulfur to the lithium anode and lead to undesired parasitic reactions. This shuttle effect can also result in random deposition of Li₂S₂ and Li₂S on the cathode, which can dramatically alter the cathode morphology and thus lead to rapid capacity fading. Further, similar to Si, Ge and Sn anodes (all of which exhibit substantial volume changes during cycling), significant volume change of sulfur during cycling can result in cracking and pulverization, such as may also lead to rapid capacity fading.

Various approaches have been investigated and reported involving efforts to overcome one or more these three major issues, shortcomings or deficiencies. For example, in US 20120088154 and US 20140017569, doped carbon framework or graphene are used to serve as a conductive network and polysulfide immobilizer for sulfur cathodes. In US 20120264017 and US 20130065128, sulfur is placed within the interior of hollow carbon nanotubes in an attempt to prevent direct contact with the electrolyte. In addition, cathodes starting with Li₂S have also been pursued. In US 20110200883 and US 20110165466, Li₂S is introduced to a conductive, porous structure which serves as the conductive network and provides physical barriers to slow down the dissolution of polysulfides into the electrolyte. Efforts to address the problem of polysulfide dissolution has also included possible modifications to the electrolyte. For example, in US 20130295469 the electrolyte is composed of Li₂S composites, whereas in US 20120094189, the electrolyte is made of a mixture of polymer powder and a lithium salt.

While the approaches discussed above may have resulted in some improvement of the properties of Li—S batteries, further improvements are desired and needed. For example, the prior art has failed to show or disclose Li—S cathodes of sufficient stability to satisfy the DOE's target performance of at least 1000 cycles.

### SUMMARY OF THE INVENTION

This invention provides novel encapsulated Li₂S nanoparticles as well as associated or corresponding cathodes of Li/S batteries and methods of fabrication such as to effectively minimize or desirably overcome or resolve all three of the above-identified issues that can commonly contribute to the rapid capacity fading of Li/S batteries during cycling.

In accordance with one aspect of the subject development, there is provided a chargeable/dischargeable composition of matter that includes a core component including lithium sulfide particles and a shell component encapsulating the core component. The shell component is desirably composed or made of a material having sufficient ionic and electronic conductivity to enable charge and discharge rates of at least 1/10 C.

Specific embodiments include:

such a composition wherein the lithium sulfide particles are of a size selected from the group consisting of micron, submicron and a combination thereof;

such a composition wherein the lithium sulfide particles are of a size of 1 micron or less;

such a composition wherein the lithium sulfide particles are of a size of less than 750 nanometers;

such a composition wherein the lithium sulfide particles are of a size of 100-500 nanometers;

such a composition wherein the shell component material is selected from the group consisting of metal, ceramic, polymer and non-metal materials;

such a composition wherein the shell component material is a non-metal;

such a composition wherein the non-metal is selected from the group consisting of carbon, silicon and combinations thereof;

such a composition wherein the non-metal is carbon;

such a composition wherein the shell component is a metal material;

such a composition wherein the shell component is a ceramic material;

such a composition wherein the ceramic material is Y-doped Li₄Ti₅O₁₂; such a composition wherein the shell component is a polymer material; and

such a composition wherein the shell component comprises a material having sufficient ionic and electronic conductivity to enable charge and discharge rates of at least 1 C.

Other aspects of the development include cathodes made of such compositions as well as method of making such compositions.

In accordance with another aspect of the subject development, there is provided a cathode that includes shell-encapsulated lithium sulfide nanoparticles. The shell-encapsulated lithium sulfide nanoparticles include a core component comprising lithium sulfide nanoparticles and a shell component that encapsulates the core component. The shell component is of a material having sufficient ionic and electronic conductivity to enable charge and discharge rates of at least 1 C.

While the broader practice of the invention is not necessarily limited to encapsulated lithium sulfide particles of specific or particular dimensions, in accordance with certain particular aspects of the invention cores that include Li₂S nanoparticles of 100 to 500 nm can be advantageously employed. Further, the invention can advantageously employ encapsulating shells having a thickness of 5 to 15 nm.

As used herein, references to a material having “sufficient” ionic and/or electronic conductivity are to be understood to generally refer to the material having such conductivity such as to enable charge and discharge rates of at least 1/10 C and, preferably, at least 1 C.

### BRIEF DESCRIPTION OF THE DRAWINGS

Objects and features of this invention will be better understood from the following description taken in conjunction with the drawings, wherein:

FIG. 1 is a schematic illustration of an encapsulated Li₂S nanoparticle in accordance with one embodiment of the invention and showing charge and discharge thereof, respectively.

FIG. 2 is a flowchart showing the synthesis of encapsulated Li₂S nanoparticles in accordance with selected embodiments of the invention. More specifically:

FIG. 2a illustrates three methods for formation of Li₂S nanoparticles, including:
(i) high-energy ball milling,
(ii) sol-gel synthesis via bubbling H₂S through a LiCl solution, and
(iii) reduction of S by lithium triethylborohydride;

FIG. 2b illustrates formation of a Y-doped Li₄Ti₅O₁₂ shell and its infiltration into a porous nano-Li₂S core via sol-gel approach;

FIG. 2c illustrates conversion of an amorphous Y-doped Li₄Ti₅O₁₂ to a crystalline counterpart at 600° C. in argon;

FIG. 2d illustrates formation of a carbon shell and its infiltration into a porous nano-Li₂S core via solvothermal treatment of Li₂S nanoparticles in pyrrole at 550° C.; and

FIG. 2e illustrates formation of a carbon shell via CVD.

FIG. 3 shows scanning electron microscopy (SEM) images of ball milled Li₂S particles (a) with and (b) without carbon encapsulation.

FIG. 4 shows transmission electron microscopy (TEM) images of ball milled Li₂S particles with carbon encapsulation at different magnifications.

FIG. 5a depicts the voltage profile as a function of charge/discharge time for the 10^{th} and 11^{th} cycles with 0.5 C rate after the initial activation process at 1/20 C, and

FIG. 5b shows the cycling performance of the specific capacity of the ball milled Li₂S cathode without carbon encapsulation.

FIG. 6a depicts the voltage profile as a function of specific capacity for the 2^{nd} charge/discharge cycles with 0.5 C rate after the initial activation process at 1/20 C, and

FIG. 6b shows the cycling performance of the specific capacity of the ball milled Li₂S cathode with carbon encapsulation.

FIG. 7 shows cyclic voltammograms as a function of the scan number for the ball milled Li₂S with carbon encapsulation. The scan rate=0.25 mV/s.

FIG. 8 shows cyclic voltammograms as a function of the scan number for the ball milled Li₂S without carbon encapsulation. The scan rate=0.25 mV/s.

### DESCRIPTION OF PREFERRED EMBODIMENTS

As described in greater detail below, the invention generally relates to novel encapsulated lithium sulfide particles, e.g., Li₂S nanoparticles, as well as associated or corresponding novel cathodes of or for Li/S batteries and methods of fabrication such as to effectively minimize or desirably overcome or resolve all three of the above-identified issues that can commonly contribute to the rapid capacity fading of Li/S batteries during cycling.

More particularly, novel cathodes in accordance with certain preferred embodiments of the invention are desirably composed of encapsulated lithium sulfide particles, e.g., Li₂S nanoparticles, such as have a Li₂S core and a shell having both high electronic conductivity and high Li-ion conductivity, e.g., having sufficient ionic and electronic conductivity to enable charge and discharge rates of at least 1/10 C, preferably, to enable charge and discharge rates of at least 1 C.

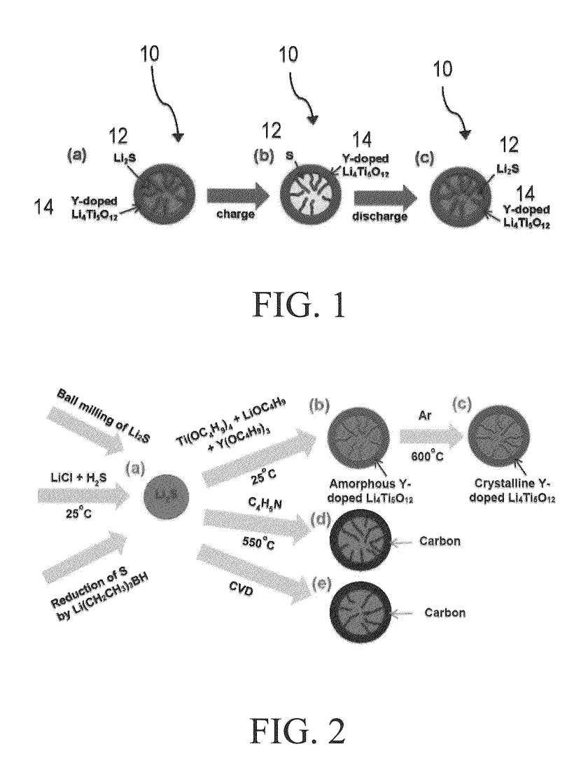

A schematic of an encapsulated Li₂S nanoparticle in accordance with one embodiment of the invention and generally designated by the reference numeral 10 is shown in FIG. 1a. The encapsulated Li₂S nanoparticle 10 includes a core 12 composed of Li₂S nanoparticle(s) and a nano-shell 14 such composed of Y-doped Li₄Ti₅O₁₂.

Those skilled in the art and guided by the teachings herein provided will understand and appreciate that the nano-shell 14 can and desirably does serve multiple functions. For example, the nano-shell 14 can act or serve to prevent the dissolution of intermediate lithium polysulfides products (Li₂Sₓ, 4≦x≦8) into the electrolyte. Further, the nano-shell 14 can act or serve as a nano-substrate to accommodate large volume expansion of sulfur (˜80%) during cycling. Still further, the nano-shell 14 can solve or cure the problem of the insulating nature of Li₂S and S by offering a pathway for electron and Li-ion transport during cycling.

Those skilled in the art and guided by the teachings herein provided will understand and appreciate that the subject development, such as by or with encapsulated Li₂S nanoparticles such as herein disclosed, by reducing, minimizing and preferably solving one or more and preferably each of the three above-identified critical problems that have hindered the commercialization of rechargeable Li/S batteries, can and desirably will enable the construction of Li/S batteries with ultrahigh energy densities and long cycle life, as elaborated below. For example, encapsulated Li₂S nanoparticles in accordance with the invention can prevent direct contact of the electrolyte with the Li₂S core and thus completely eliminate dissolution of polysulfides.

As noted above, like Si, Ge and Sn anodes (all of which have substantial volume change during cycling), significant volume change of sulfur during cycling can result in cracking and pulverization, leading to rapid capacity fading. Encapsulated Li₂S nanoparticles such as herein described and/or provided in accordance with certain preferred embodiments of the invention desirably avoid or resolve such problems or concerns such as via the nano-shell while simultaneously preventing dissolution of polysulfides into the electrolyte. Further, given the facts that the volume expansion of Si during lithiation is about 400% whereas the volume expansion of S during lithiation is only 80%, encapsulated Li₂S nanoparticles in accordance with the invention are expected to have a cycle life of more than 5,000 cycles, exceeding the most recent DOE targets for both plug-in hybrid electric vehicles with a 40 mile all electric range (PHEV40) and full electric vehicles (EVs).

Specifically, taking a Li₂S core/Y-doped Li₄Ti₅O₁₂ shell nanoparticle as an example (FIG. 1a), the Li₂S core 12 will shrink during charge to form a hollow sphere (FIG. 1b), but the core 12 will become a solid core again during discharge (FIG. 1c). In these charge/discharge cycles, the outer Y-doped Li₄Ti₅O₁₂ nano-shell 14 and the Y-doped Li₄Ti₅O₁₂ penetrating network inside the nano-Li₂S core 12 will serve as nano-substrates to which S, polysulfides and Li₂S can attach. Such attachment not only offers the structure improved integrity for the cathode (i.e., no cracking and pulverization), but also allows rapid electron and Li-ion transport required for electrochemical reactions.

Since, as detailed herein, the outer shell that encapsulates the Li₂S core preferably needs to afford good ionic and electronic conductivity, the selection of the outer shell material is important for providing or resulting in encapsulated Li₂S nanoparticles that function as desired. While the invention has been described above making specific reference to an embodiment wherein the shell comprises or is made of Y-doped Li₄Ti₅O₁₂, those skilled in the art and guided by the teachings herein provided will understand and appreciate that the shell component may desirably comprise other materials having sufficient ionic and electronic conductivity such as to enable charge and discharge rates of at least 1/10 C, and preferably to enable charge and discharge rates of at least 1 C.

Accordingly, in other selected embodiments, the shell component can be made or composed of non-metal materials such as carbon (5 to 15 nm), silicon or combinations thereof; ceramic materials such as Y-doped Li₄Ti₅O₁₂ and La-doped Li₄Ti₅O₁₂, for example; polymers; metals; or other desired materials that possess both high electronic and ionic conductivities.

Carbon can be used as a shell material to encapsulate the Li₂S core. Carbon has been found to exhibit superior electronic conductivity and thin carbon films (2 to 10 nm) permit easy Li-ion transport. Y-doped and La-doped Li₄Ti₅O₁₂ are also excellent shell materials because their high electronic and ionic conductivities. The doping of La³⁺ or Y³⁺ cations to partially replace Ti⁴⁺ in Li₄Ti₅O₁₂ can lead to an order-of-magnitude increase in both electronic and ionic conductivities. As a result of these enhancements, Y-doped Li₄Ti₅O₁₂ can be used to build an anode without carbon black and still exhibit a reversible capacity of 112 mAh/g after 500 cycles at 5 C, markedly better than a cell made of Li₄Ti₅O₁₂ using carbon black as the conductive material. Another advantage of Y-doped Li₄Ti₅O₁₂ is that its volume change during cycling is almost zero. Therefore, Y-doped Li₄Ti₅O₁₂ can serve as a superior shell material to maintain the structure integrity of the cathode while providing a highway for electron and Li-ion transport.

The subject invention development further encompasses viable routes, methods and processes for making, forming or synthesizing the subject chargeable/dischargeable composition of matter. Those skilled in the art and guided by the teachings herein provided will understand and appreciate that depending on the size of Li₂S particles and the chemistry of the shell material, the synthesis route can be appropriately varied. For example, FIG. 2 depicts several routes, in accordance with various embodiments of the invention, for making encapsulated Li₂S nanoparticles. For example, Li₂S core particles can be made by various techniques such as including but not necessarily limited to via high-energy ball milling, sol-gel method, or reduction of sulfur by lithium triethylborohydride, as shown in FIG. 2a.

High-energy ball milling is a well-established method to form nanoparticles with sizes such as in orange of 100 to 500 nm. Example 1 in the Examples section below further details the effectiveness of high-energy ball milling in forming Li₂S nanoparticles. For the sol-gel method, in accordance with one embodiment, lithium chloride (LiCl) can be used as the sol-gel precursor. However, many other precursor materials including, for example, lithium alkoxides (such as LiOC₂H₅), lithium nitrate (LiNO₃), lithium citrate (Li₃C₆H₅O₇), lithium acetate (LiC₂H₃O₂), etc. can be used as the sol-gel precursor, if desired.

In general and in accordance with one embodiment of the invention, the making of Li₂S nanoparticles using LiCl as a precursor can involve:
(i) dissolving LiCl in toluene (99.8%),
(ii) bubbling H₂S through the LiCl solution for 30 min at room temperature in a closed Schlenk vessel with propionic acid as a catalyst, and
(iii) aging the solution for a desired period of time (e.g., 1 to 7 days, depending on the desired size of nanoparticles) at room temperature with continuous stirring.

The formation of Li₂S nanoparticles via reduction of sulfur by lithium triethylborohydride, can involve first dissolving sulfur in toluene and then adding sulfur-containing toluene into a solution of lithium triethylborohydride in tetrahydrofuran (THF). The mixing of the two solutions will lead to the following chemical reaction with the precipitation of Li₂S nanoparticles:

S+2Li(CH₂CH₃)₃BH═Li₂S+2(CH₂CH₃)₃B+H₂

After the formation of Li₂S nanoparticles, encapsulation of Li₂S particles can be done also via various methods such as may at least in part depend on the nature of the shell material. For example, one can form a non-metal (e.g., carbon, silicon or combination thereof) nano-shell, ceramic (e.g., Y-doped Li₄Ti₅O₁₂) nano-shell, metal nano-shell, or polymer nano-shell. For example, to form the Y-doped Li₄Ti₅O₁₂ nano-shell (FIGS. 2b & 2c), the sol-gel precursors of Ti(OC₄H₉)₄, Y(OC₄H₉)₃ and LiOC₄H₉ can be mixed and added directly to the Li₂S sol in toluene (e.g., Li₂S nanoparticles made via the sol-gel method with LiCl as the precursor). After the complete dissolution and uniform mixing of all of the alkoxide precursors in toluene, deionized water with a proper pH value (pH<3) can be titrated into the alkoxide+Li₂S sol mixture under magnetic stirring at room temperature. This will result in Li₂S core/Y-doped Li₄Ti₅O₁₂ shell nanoparticles. Furthermore, some of the Y-doped Li₄Ti₅O₁₂ material will infiltrate into the porous Li₂S core, as shown schematically in FIG. 1b. Such infiltration is possible because it is well known that as synthesized sol-gel products contain high volume fraction of pores (with sizes from subnanometers to tens of nanometers). Indeed, it has been shown recently that nano-Ag derived from the reduction of an AgNO₃ solution can infiltrate into porous Si spheres synthesized via sol-gel processing. Such infiltration is expected to offer electronic and ionic conductivities within the nano-Li₂S core, and thus enhance the electrochemical performance and cycle stability. Finally, to obtain a dense and crystalline Y-doped Li₄Ti₅O₁₂ shell with good electronic and ionic conductivities, the Li₂S core/Y-doped Li₄Ti₅O₁₂ shell nanoparticles will be subjected to further treatment such as calcination, such as treatment at 600° C. for 5 hours in argon, before being used to make the cathode (FIG. 2c). The Li₂S core/La-doped Li₄Ti₅O₁₂ shell nanoparticles can be synthesized in the same way except replacing the dopant Y with La.

To synthesize Li₂S core/C shell nanoparticles (FIG. 2d), a carbon shell is coated on the surface of the as-synthesized nano-Li₂S core. The carbon shell can he formed in aqueous environments through the polymerization and carbonization of glucose or in non-aqueous environments with the aid of pyrrole. However, Li₂S can decompose in water. As a result, aqueous approaches with hydrothermal treatment of glucose are generally not suitable for depositing the C shell. In contrast, the pyrrole approach in non-aqueous environments can be used. The solvothermal treatment of the pyrrole approach desirably needs to be carried out at 550° C. in an autoclave (FIG. 2d) but with no need for the subsequent carbonization. Similar to the case of forming the Y-doped Li₄Ti₅O₁₂ shell discussed above, it is expected that carbon will penetrate into the nano-Li₂S core, and thus enhance the electrochemical performance and cycle stability of Li₂S core/C shell nanoparticles.

The carbon shell on the surface of the Li₂S nanoparticles can also be formed via chemical vapor deposition (CVD) of methane or acetylene at suitable temperature (FIG. 2e). CVD is known for its capability in forming thin conformal coatings on complex-shaped components, including the inside and underside features. Therefore, CVD is suitable for forming the carbon shell on the surface of dry Li₂S nanoparticles.

Thus, suitable methods of encapsulation in selected embodiments can for example include chemical vapor deposition (CVD) such as of carbon, sol-gel deposition such as of Y-doped Li₄Ti₅O₁₂, and solvothermal treatment of pyrrole such as to form a carbon shell.

The present invention is described in further detail in connection with the following examples which illustrate or simulate various aspects involved in the practice of the invention. It is to be understood that all changes that come within the spirit of the invention are desired to be protected and thus the invention is not to be construed as limited by these examples.

### EXAMPLES

### Example 1

### Formation of Li₂S Nanoparticles Encapsulated with Carbon

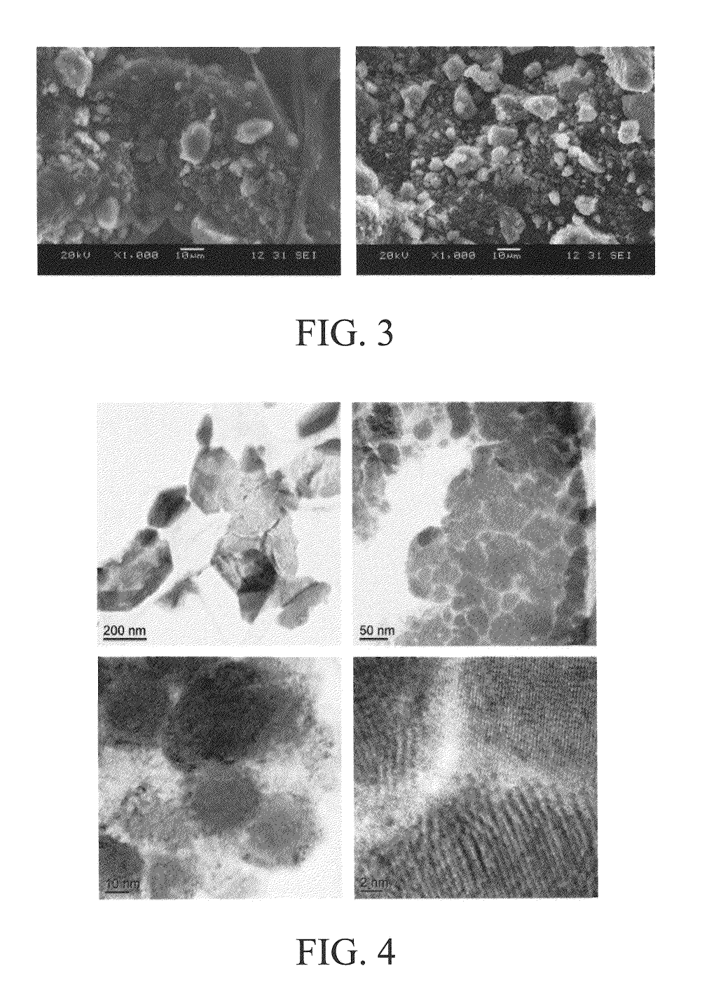

1 gram of commercial Li₂S powder was mixed with 0.075 g carbon black and high-energy ball milled for 6 hours with 20 g steel balls in a SPEX mill under an argon atmosphere. The ball milled powder mixture was then loaded into an autoclave. 0.4 ml pyrrole was added to the autoclave before being sealed inside a glove box filled with argon. The loaded autoclave was heated to 600° C. and held at that temperature for 8 hours. After the autoclave was cooled down, it was opened inside a glove box for collecting powder. FIG. 3 shows the scanning electron microscopy (SEM) images of ball milled Li₂S particles with and without carbon encapsulation. As shown, the sizes of the ball milled Li₂S particles are not uniform. Sizes as large as 10 μm are present together with small particles of less than 1 mm. Furthermore, the general morphology of Li₂S particles before and after carbon encapsulation looks the same, indicating the carbon shell is very thin. FIG. 4 shows the transmission electron microscopy (TEM) images of ball milled Li₂S particles with carbon encapsulation. Again the particle size was not uniform, but TEM imaging reveals that many particles have sizes at 50 nm or smaller. Furthermore, a distinct layer (i.e., the carbon shell) is clearly visible outside the Li₂S particles (about 5 nm thick).

### Example 2

### Electrochemical Measurements of Li₂S with and without Carbon Shell Encapsulation

Ball milled Li₂S powders with and without carbon encapsulation from Example 1 were used to make cathodes. More particularly, 120 mg Li₂S powders with and without carbon encapsulation were mixed separately with carbon black and polyvinylidene fluoride (PVDF) with a weight ratio of 8:1:1 using a mortar and pestle, followed by adding N-methyl-2-pyrrolidinone (NMP) solvent to form a slurry. The slurry was coated onto an aluminum foil and dried at 60° C. for 12 h and then 110° C. for another 12 h.

The anode was a Li foil, whereas the electrolyte was made of a solution of lithium bis(trifluoromethanesulfonyl)imide (LiTFSI, 1 M) in 1,2-dimethoxyethane (DME) and 1,3-dioxolane (DOL) with a volume ratio of 1:1 containing LiNO₃ additive (1 wt %). CR2032 coin cells were made using the aforementioned cathode, anode and electrolyte. Galvanostatic charge/discharge cycling and cyclic voltammetry were carried out using a Princeton Applied Research battery tester. The batteries were first activated at C/20 (1 C=1,166 mA g⁻¹) by charging to a high cutoff voltage of 4.0 V vs. Li⁺/Li to overcome the initial potential barrier, followed by discharge to 1.5 V. Galvanostatic cycling was then carried out from 1.5 to 3.0 V vs. Li⁺/Li. The specific capacity values were calculated based on the mass of Li₂S.

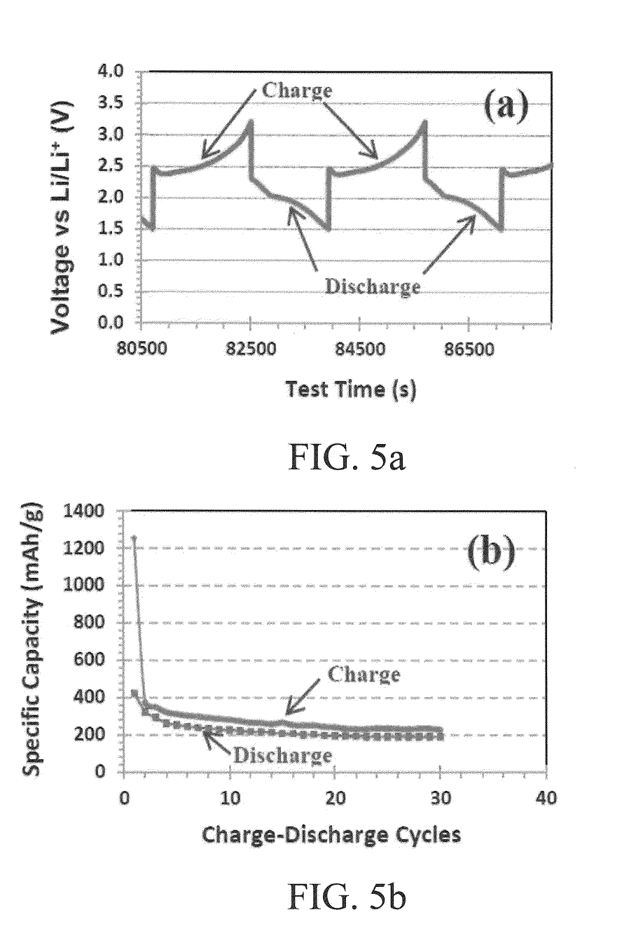

FIG. 5a shows the voltage profile as a function of the galvanostatic charge/discharge time for the 10^{th} and 11^{th} cycles of CR2032 coin cells made of the ball milled Li₂S cathode. Clearly, the discharge curve includes two voltage plateaus, corresponding to the formation of soluble intermediate lithium polysulfides (Li₂Sₓ²⁻, 4≦x≦8) and subsequently the formation of insoluble Li₂S₂ and finally Li₂S with further discharging. The charge curve shows a small hump at the early stage of charge, which is due to the barrier for phase nucleation. The cycling performance is shown in FIG. 5b. Clearly, the specific capacity was low, only about 200 mAh/g after 20 cycles. The poor cycling performance is attributable to polysulfide dissolution and the shuttle phenomenon.

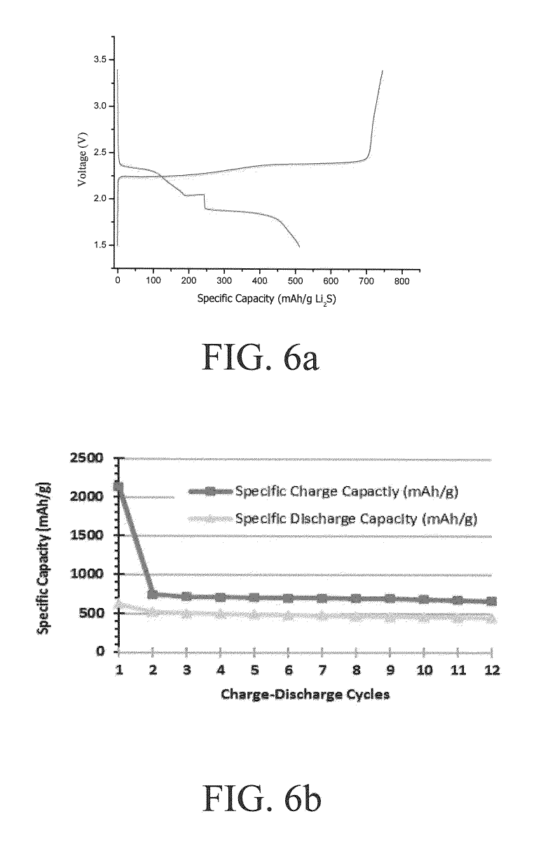

FIG. 6a shows the voltage profile as a function of the galvanostatic charge/discharge capacity for the 2^{nd} cycle of a CR2032 coin cell made of the ball milled Li₂S cathode with carbon encapsulation. It is noted that the charge/discharge curves are similar to those of CR2032 cells made of the ball milled Li₂S cathode but without carbon encapsulation. However, the discharge capacity of the ball milled Li₂S cathode with carbon encapsulation has exhibited more than 100% improvement over the counterpart without carbon encapsulation (e.g., about 500 mAh/g for the cathode with carbon encapsulation versus about 200 mAh/g for the cathode without carbon encapsulation at the 10^{th} cycle). The significant improvement in the discharge capacity is attributable to the carbon encapsulation which prevents the polysulfide dissolution and shuttle phenomenon.

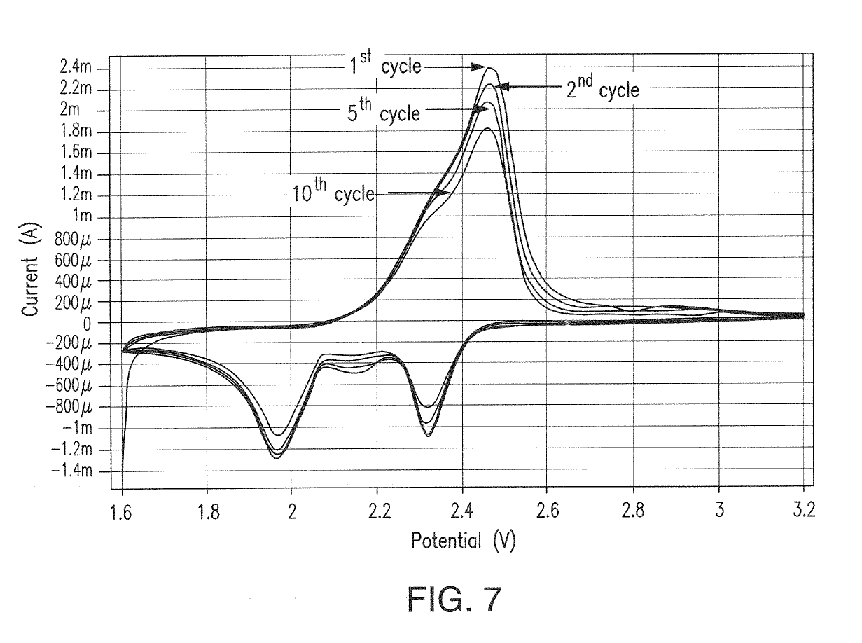

FIG. 7 depicts the cyclic voltammogram (CV) of the ball milled Li₂S cathode with carbon encapsulation. Two obvious cathodic peaks can be seen at around 2.35 V and 1.97 V, respectively, corresponding to the transitions of sulfur/high-order polysulfides to low-order polysulfides and then to the end discharge product Li₂S, respectively. An anodic peak at about 2.45 V along with a distinguishable shoulder peak at about 2.3 V was also observed. The CV data was consistent with the galvanostatic charge/discharge profile shown in FIG. 6a.

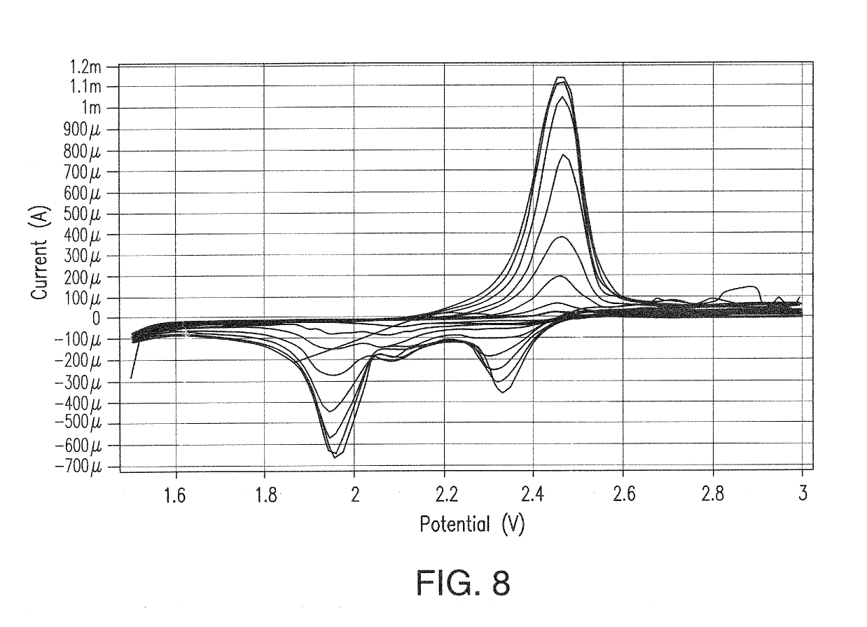

FIG. 8 depicts the cyclic voltammogram of the ball milled Li₂S cathode without carbon encapsulation. The CV data was similar to that of the ball milled Li₂S cathode with carbon encapsulation. However, the shoulder peak at about 2.3 V observed in the ball milled Li₂S cathode with carbon encapsulation was absent, suggesting that the carbon shell has modified the charging reactions slightly.

While the such development has been described above making specific reference to encapsulation of lithium sulfide particles of submicron dimensions, e.g., lithium sulfide nanoparticles nanoparticles, including in accordance with one preferred embodiment lithium sulfide particles of a size of less than 750 nanometers and in accordance with another preferred embodiment lithium sulfide particles of a size of 100-500 nanometers, those skilled in the art and guided by the teachings herein provided will understand and appreciate that the broader practice of the invention is not necessarily so limited. For example, if desired, the invention can be employed using lithium sulfide particles of various size, including those of a size selected from the group consisting of micron, submicron and a combination thereof, including lithium sulfide particles of a size of 1 micron or less.

The invention illustratively disclosed herein suitably may be practiced in the absence of any element, part, step, component, or ingredient that is not specifically disclosed herein.

While in the foregoing detailed description this invention has been described in relation to certain preferred embodiments thereof, and many details have been set forth for purposes of illustration, it will be apparent to those skilled in the art that the invention is susceptible to additional embodiments and that certain of the details described herein can be varied considerably without departing from the basic principles of the invention.

What is claimed is:

1. A chargeable/dischargeable composition of matter comprising:
a core component comprising lithium sulfide particles, and
a shell component encapsulating the core component, the shell component comprising a material having sufficient ionic and electronic conductivity to enable charge and discharge rates of at least 1/10 C.

2. The composition of claim 1 wherein the lithium sulfide particles are of a size selected from the group consisting of micron, submicron and a combination thereof.

3. The composition of claim 2 wherein the lithium sulfide particles are of a size of 1 micron or less.

4. The composition of claim 3 wherein the lithium sulfide particles are of a size of less than 750 nanometers.

5. The composition of claim 4 wherein the lithium sulfide particles are of a size of 100-500 nanometers.

6. The composition of claim 1 wherein the shell component material is selected from the group consisting of metal, ceramic, polymer and non-metal materials.

7. The composition of claim 6 wherein the shell component material is a non-metal.

8. The composition of claim 7 wherein the non-metal is selected from the group consisting of carbon, silicon and combinations thereof

9. The composition of claim 7 wherein the non-metal is carbon.

10. The composition of claim 6 wherein the shell component is a metal material.

11. The composition of claim 6 wherein the shell component is a ceramic material.

12. The composition of claim 11 wherein the ceramic material is Y-doped Li₄Ti₅O₁₂.

13. The composition of claim 6 wherein the shell component is a polymer material.

14. The composition of claim 1 wherein the shell component comprises a material having sufficient ionic and electronic conductivity to enable charge and discharge rates of at least 1 C.

15. A cathode comprising the composition of claim 1.

16. A method of making the composition of claim 1, the method comprising:
forming lithium sulfide nanoparticles and
forming the shell component by a technique selected from the group consisting of, for a Y-doped Li₄Ti₅O₁₂ shell, a sol-gel preparation of amorphous Y-doped Li₄Ti₅O₁₂ followed by conversion of amorphous Y-doped Li₄Ti₅O₁₂ to a crystalline counterpart and, for a carbon shell, solvothermal treatment of Li₂S nanoparticles in pyrrole at elevated temperature or via chemical vapor deposition.

17. The method of claim 16 wherein the lithium sulfide nanoparticles are formed by a technique selected from the group consisting of ball milling, sol-gel synthesis via bubbling H₂S through a LiCl solution and reduction of S by lithium triethylborohydride.

18. A cathode comprising:
shell-encapsulated lithium sulfide nanoparticles, the shell-encapsulated lithium sulfide nanoparticles comprising:
a core component comprising lithium sulfide nanoparticles, and
a shell component encapsulating the core component, the shell component comprising a material having sufficient ionic and electronic conductivity to enable charge and discharge rates of at least 1 C.

19. The cathode of claim 18 wherein the lithium sulfide nanoparticles are of a size of 100-500 nanometers.

20. The cathode of claim 18 wherein the shell component material comprises carbon.
